(19) United States
(12) Patent Application Publication
(10) Pub. No.: US 2002/0109118 A1
(43) Pub. Date: Aug. 15, 2002

(54) Web supported hollow sphere valve

(75) Inventor: Barry T. Brinks, Fort Collins, CO (US)

Correspondence Address: LEYDIG VOIT & MAYER, LTD, 6815 WEAVER ROAD, ROCKFORD, IL, 61114-8018, US

(73) Assignee: Woodward Governor Company, Fort Collins, CO (US)

(21) Appl. No.: 09/784,564

(22) Filed: Feb. 15, 2001

(51) Int. Cl. F16K 5/06

(52) U.S. Cl. 251/209; 251/315.16

(57) ABSTRACT

A valve system is presented that has a thin walled hollow sphere connected to the valve shaft. The hollow sphere has ports in the sphere wall to allow fluid to enter and exit the hollow sphere. An adjacent flow path is formed by a pressure balanced tube that is biased against the thin walled hollow sphere. The thin walled hollow sphere is supported by plates that are located parallel to the fluid flow path.

### FIELD OF THE INVENTION

This invention pertains to valves, and more particularly to ball valves.

### BACKGROUND OF THE INVENTION

Generally, a ball valve includes a housing or body having an internal valve chamber within inlet and outlet passages. A ball valve member is disposed within the internal valve chamber. The ball valve member comprises a ball positioned centrally within the chamber and a cylindrical valve stem which extends from the ball axially through the chamber to a location outside the body. A handle or actuator attached to the operating stem allows the ball to be rotated, thereby selectively aligning passages in the ball with the inlet and outlet passages in the body.

Ball valves are used in a large number of commercial and residential applications to control both liquid and gas fluid flow. The amount of fluid flowing through a valve can be predicted by knowing the type of fluid, the fluid temperature, the fluid pressure at the valve inlet and also at the valve outlet, and the effective area of the valve flow port. The valve effective area is the actual open area of the valve port multiplied by a factor that accounts for the actual flow rate deviating from the predicted flow rate based only on the geometric port area. The valve action occurs by the moving of separate components relative to each other to change a flow area for the fluid to pass through. Reducing the flow area increases the flow impedance and reduces the flow. Increasing the flow area allows more flow.

Existing ball valves consist of a solid sphere with a hole bored through it or a thick walled hollow sphere with holes. The edges of the thick walls have components of the surface normal facing perpendicular to the radial direction from the axis of revolution causing local fluid pressures to generate significant flow induced forces. These ball valves often have shoe elements that push very hard against the sphere in order to seal the sphere to achieve low leakage. This results in a very tight friction fit. The combined effects of high friction and high flow forces results in high torque needed to rotate the sphere in order to change fluid flow. What is needed is ball valve that has low leakage, low friction, and low flow induced forces, and that needs only a low torque to rotate the sphere.

### SUMMARY OF THE INVENTION

In view of the above, the instant invention provides a hollow sphere valve with a moving element that approximates a volume of revolution and provides low flow forces and that is capable of operation with extreme fluid temperatures.

The instant invention uses either a pressure balanced or a matched deflection adjacent flow path with minimal area in contact with the hollow sphere to provide a valve that can minimize the contact force between the outside diameter of the sphere and the adjacent flow path resulting in low friction forces.

The hollow sphere valve minimizes the gap between the outside diameter of the sphere and the adjacent flow path at any valve position and subjected to various pressure differentials across the valve to provide low leakage around the valve's metering port and thus provides accurate flow control in the forward and reverse flow direction, a large flow turn down ratio, and low shutoff leakage with pressure differential in either direction.

The hollow sphere valve provides a valve that is capable of a high differential pressure rating due to low elastic stress levels under load. The hollow sphere valve also has a sphere supporting structure that has a small cross section, which results in a valve that is capable of a high flow capacity rating due.

Additional features and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention, and together with the description serve to explain the principles of the invention. In the drawings:

FIG. 1 is a cross-sectional view showing a valve assembly constructed in accordance with one embodiment of the present invention;

FIG. 2 is a cross-sectional view showing a valve assembly constructed in accordance with an alternate embodiment of the present invention;

FIG. 3 is a rotated isometric view of the hollow sphere with a metering port and a valve shaft of the valve assembly of FIGS. 1 and 2;

FIG. 4 is a rotated isometric view of a hollow sphere with a port and a valve shaft of the valve assembly of FIGS. 1 and 2;

FIG. 5 is an isometric view of the hollow sphere and metering port and pressure balanced tube of FIG. 1;

FIG. 6 is an isometric view of the hollow sphere and port and pressure balanced tube of FIG. 1;

FIG. 7 is an isometric view of the hollow sphere and pressure balanced tube of FIG. 5 at a location where the valve assembly is partially opened; and

FIG. 8 is an isometric view of the hollow sphere and pressure balanced tube of FIG. 5 at a location where the valve assembly is more than halfway opened.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE PREFERRED EMBODIMENTS

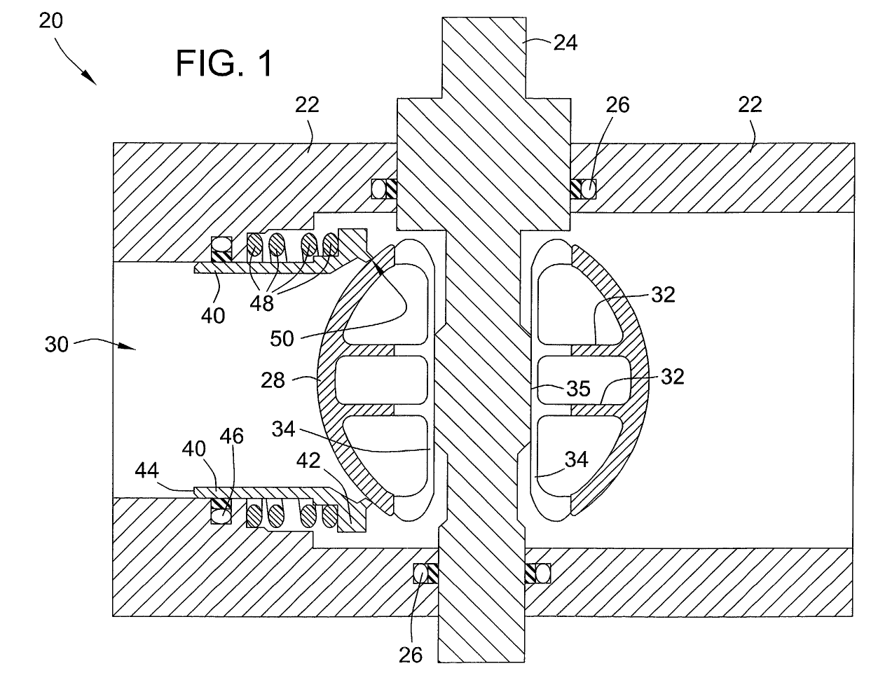

Turning to the drawings, wherein like reference numerals refer to like elements, FIG. 1 shows a hollow sphere valve generally illustrated as 20. The hollow sphere valve 20 has a valve housing 22 and a valve shaft 24. Rotation of the valve shaft 24 adjusts the valve flow area as described herein below. The valve shaft 24 is sealed by shaft seals 26 and is supported on each end by rolling element bearings (not shown). A thin wall hollow sphere 28 located in flow passage 30 is connected to the valve shaft 24 using one or more plates 32. The plates 32 are connected to a sphere support tube 34 that is attached to the valve shaft 24. Alternatively, the plates 32 may be connected directly to the valve shaft 24.

The use of the support tube 34 isolates the valve shaft 24 from forced convection with the fluid. Heat transfer into the valve shaft 24 is primarily by conduction through the attachment location 35 between the valve shaft 24 and support tube 34. Heat transfer can be reduced by minimizing the area of attachment, which results in a higher thermal impedance at the attachment area. This provides the capability to operate the hollow sphere valve 20 with extreme fluid temperature range.

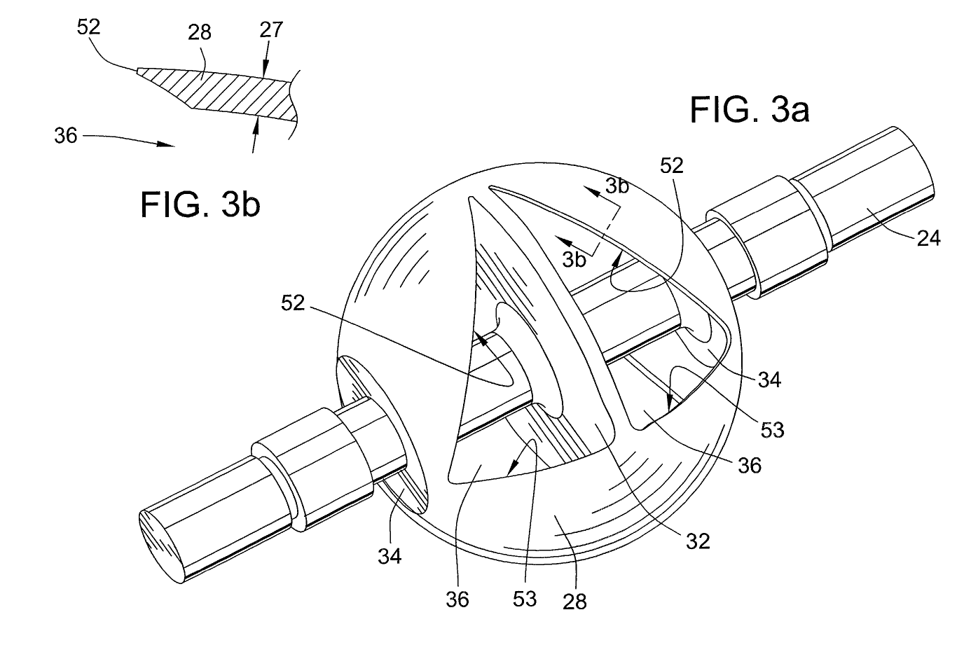

Holes (i.e., ports) 36, 38 (see FIGS. 3-8) are placed into the thin wall hollow sphere 28 to allow fluid flow to enter and exit the thin wall hollow sphere 28. The direction of flow is perpendicular to the valve shaft 24. Rotating the valve shaft 24 adjusts the flow through the internal volume of the hollow sphere by increasing or decreasing the flow port area bounded by metering port 36 in the hollow sphere and a separate component forming a circular adjacent flow path.

In one embodiment, the separate component comprises a hollow cylindrical tube 40 that is positioned against the thin wall hollow sphere 28. The end 42 of the hollow cylindrical tube 40 has a stepped diameter that allows a seal 46 to contact the outside diameter of the hollow cylindrical tube 40 at the opposite end 44 of the hollow cylindrical tube 40. The stepped diameter results in the hollow cylindrical tube 40 being nearly pressure balanced. A spring 48 or other biasing means biases the hollow cylindrical tube 40 against the thin wall hollow sphere 28.

The hollow cylindrical tube 40 is designed to minimize contact force with the outer surface of the thin wall hollow sphere 28, which results in a lower friction force between the hollow cylindrical tube 40 and the thin wall hollow sphere 28. This allows a minimum force actuator to position the valve shaft 24, resulting in a reduction in input drive power requirements and reduced size, weight and cost. The contact force is minimized by designing the end face 50 to have a small contact area with the outer surface of the thin wall hollow sphere 28, allowing the hollow cylindrical tube 40 to be nearly pressure balanced. The spring 48 has enough force such that the end face 50 maintains contact with the outer surface of the thin wall hollow sphere 28 during rotation of the valve shaft 24, resulting in low friction forces.

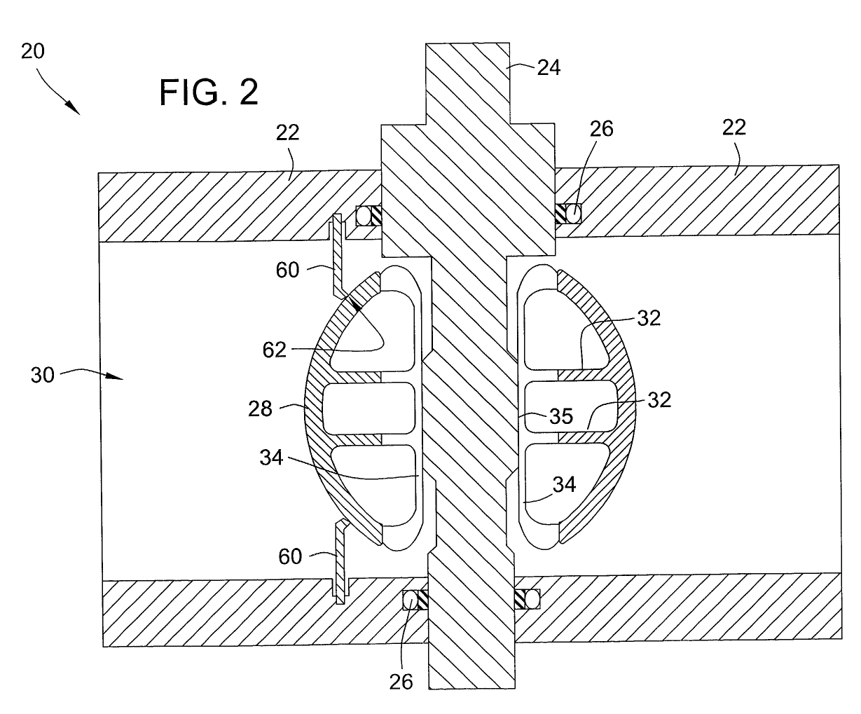

Turning now to FIG. 2, an alternate embodiment is shown. The separate component that forms a circular adjacent flow path comprises a plate 60 that is mounted in the valve housing 22. The plate has a circular hole in it and it is positioned against the thin wall hollow sphere 28 such that the face 62 formed by the circular hole contacts or nearly contacts the outer surface of the thin wall hollow sphere 28. Similar to the embodiment shown in FIG. 1, the plate 60 is designed to minimize contact force with the outer surface of the thin wall hollow sphere 28, which results in a lower friction force between the plate 60 and the thin wall hollow sphere 28. The contact force is minimized by designing the end face 62 to move with the rigid body motion of the thin wall hollow sphere 28 due to various differential pressures. The use of the plate 60 also results in low friction forces as a result of the minimized contact force, which allows a minimum force actuator to position the valve shaft 24 resulting in a reduction in input drive power requirements and reduced size, weight and cost.

In the description that follows, the term separate component shall mean the plate 60, the hollow cylindrical tube 40, and their equivalents. Turning now to FIGS. 3-8, further aspects of the thin wall hollow sphere valve 20 are shown. In FIG. 3a, the metering port 36 is shown. The metering port 36 is accurately machined to provide a profile that is made up of sharp edged surfaces 52 and surfaces 53. The wall thickness 27 (see FIG. 3b) is tapered near the metering port 36. In one embodiment, the wall thickness 27 is 0.188 inches and the wall thickness 27 tapers down to 0.030 inches at the sharp edged surfaces 52 of the metering port 36. While not shown in FIGS. 3-8, those skilled in the art will recognize that the wall thickness 27 may also be tapered at the surface 53 and that surface 53 may also be sharp edged.

Valve accuracy is obtained by minimizing leakage between the thin wall hollow sphere 28 and the separate component at any valve shaft position, including the shut-off position. The thin wall hollow sphere 28 is designed to minimize any gap that may occur due to distortion under various pressure differentials across the hollow sphere valve 20. In the embodiment shown in FIG. 1, this is accomplished by the hollow cylindrical tube 40 being nearly pressure balanced. In the embodiment shown in FIG. 2, this is accomplished by designing the plate 60 so that its deflection under differential pressure matches the rigid body deflection of the thin wall hollow sphere 28. Both embodiments provide the hollow sphere valve 20 with the capability to operate in conditions where the minimum flow is a small fraction of the maximum flow (i.e., the flow turndown ratio [maximum rated flow/minimum rated flow] is large). Additionally, the low valve leakage in the shut-off position may allow the elimination of a separate isolation valve in a system that the hollow sphere valve 20 is installed. The pressure balanced tube embodiment and matched displacement plate embodiment provides the ability to operate the valve in either or both flow directions (i.e., forward and reverse flow).

The sharp edged surfaces 52 provides repeatable and accurate effective port area, resulting in a valve that has a high accuracy of effective area versus valve position. The high accuracy allows the hollow shaft valve 20 to be used in applications where accurate control of fluid metering is required.

A valve that has low flow induced forces can be positioned with a minimum force actuator, resulting in a reduction in input drive power requirements, size, weight, and cost. A pure volume of revolution cannot generate torque about its axis of symmetry due to varying pressure loading across all surfaces. This is due to the fact that pressure loads are applied normal to the surfaces and all surface normal vectors pass through the axis of revolution and all pressure load vectors pass through the axis of revolution and produce no torque. The thin wall hollow sphere 28 approximates a volume of revolution and therefore the flow induced forces are very low.

In one embodiment, the thin walls of the thin wall hollow sphere 28 are sufficiently thin such that they do not support large pressure loading without additional support structure. The plates 32 are used to support the thin wall hollow sphere 28. The plates 32 are oriented with their flat surfaces parallel to the fluid flow path such that fluid flow is not significantly blocked, resulting in a valve that has a high flow capacity rating. The plates 32 may be circular and thin and are designed to approximate a volume of revolution. The use of the plates results in a valve that has low valve blockage and a low flow force. Distortions of the thin wall hollow sphere 28 due to differential pressure are minimized with the use of the plates 32, which allows for tight shutoff of the hollow sphere valve 20. The plates 32 are located to minimize the material stress levels, which allows high differential pressure operation. Additionally, the thinness of the thin wall hollow sphere 28 and plates 32 produces low stress levels under high differential pressure loading in either flow direction (i.e., the valve has a high differential pressure rating).

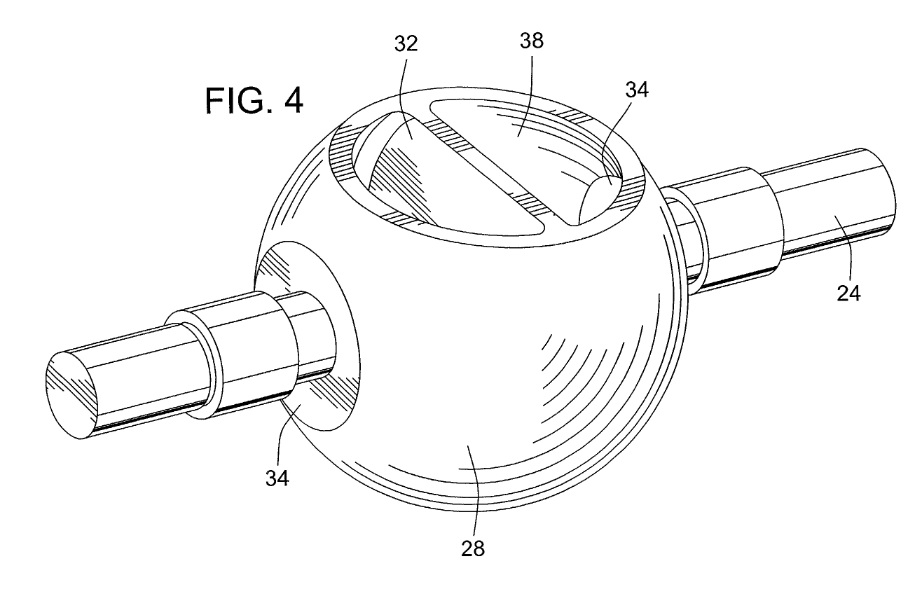

FIG. 4 shows a view of the thin wall hollow sphere 28, port 38, and valve shaft 24. The thin wall hollow sphere 28 is attached to sphere support tube 34 as previously discussed. A thin plate 32 supports the thin wall hollow sphere 28. As shown in FIGS. 3 to 8, the thin plate 32 is located along a plane that runs through the center of the thin wall hollow sphere 28. Those skilled in the art will recognize that the plate 32 can be located in planes that do not run through the center of the thin wall hollow sphere 28 (see FIGS. 1 and 2).

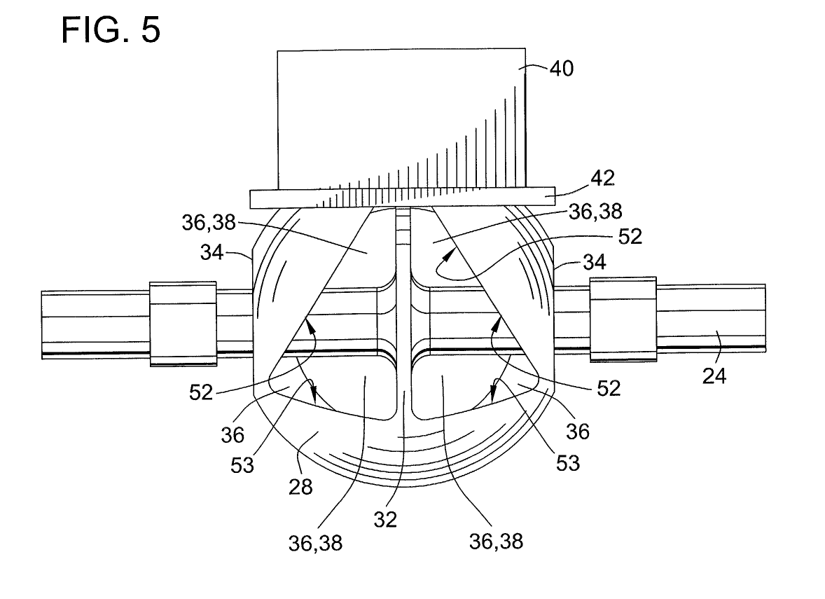

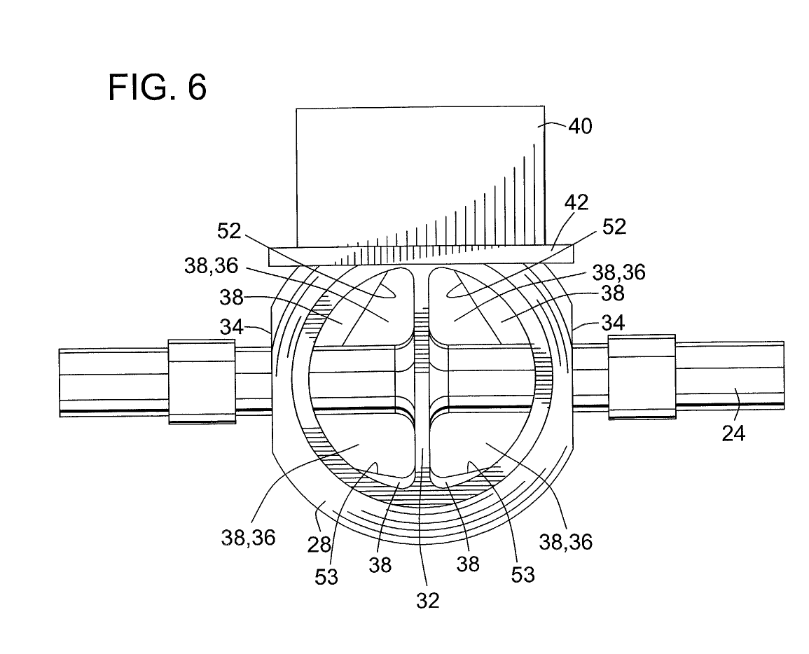

FIGS. 5-8 illustrate a portion of the hollow sphere valve 20 and hollow cylindrical tube 40 shown in FIG. 1. Turning now to FIGS. 5 and 6, a view of the thin wall hollow sphere 28 in a position where the hollow sphere valve 20 is shut-off. The hollow cylindrical tube 40 contacts the thin wall hollow sphere 28 at end 42. Spring 48 (not shown) biases end 42 against the thin wall hollow sphere 28. FIG. 5 shows a view of the thin wall hollow sphere 28 where metering port 36 is located and FIG. 6 shows a view of the thin wall hollow sphere 28 where port 38 is located. Portions of port 38 can be seen in FIG. 5 and portions of metering port 36 can be seen in FIG. 6. The figures are labeled with both port numbers (i.e., 36,38 or 38,36) in the areas where both ports 36, 38 can be seen and with one port number where only one port can be seen. For example, FIG. 5 shows labels for ports 36,38 in locations where metering port 36 and port 38 can be seen and labels for port 36 in locations where port 38 is not located on the other side of the thin wall hollow sphere 28.

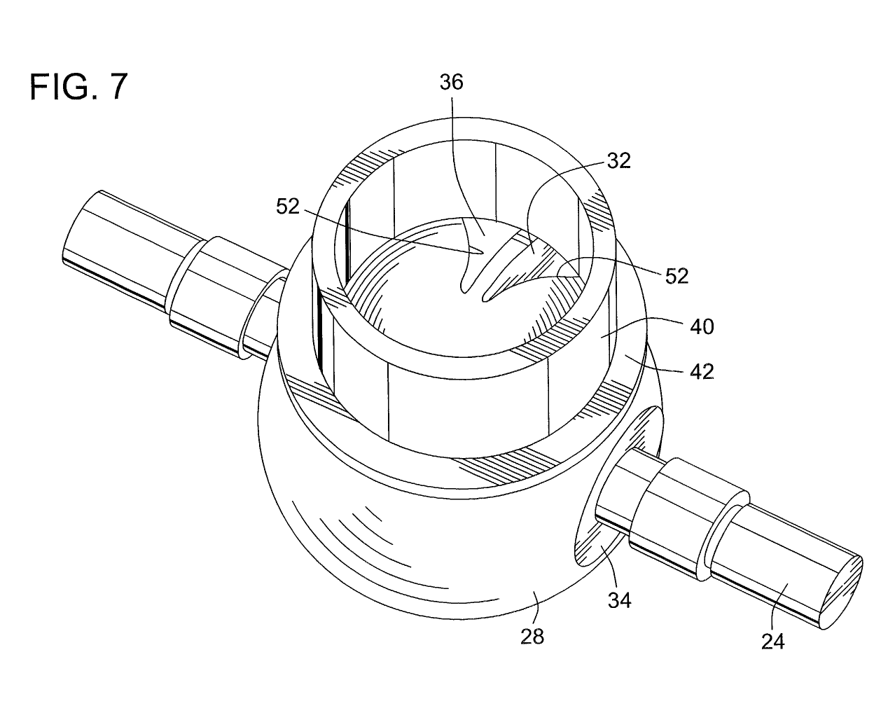

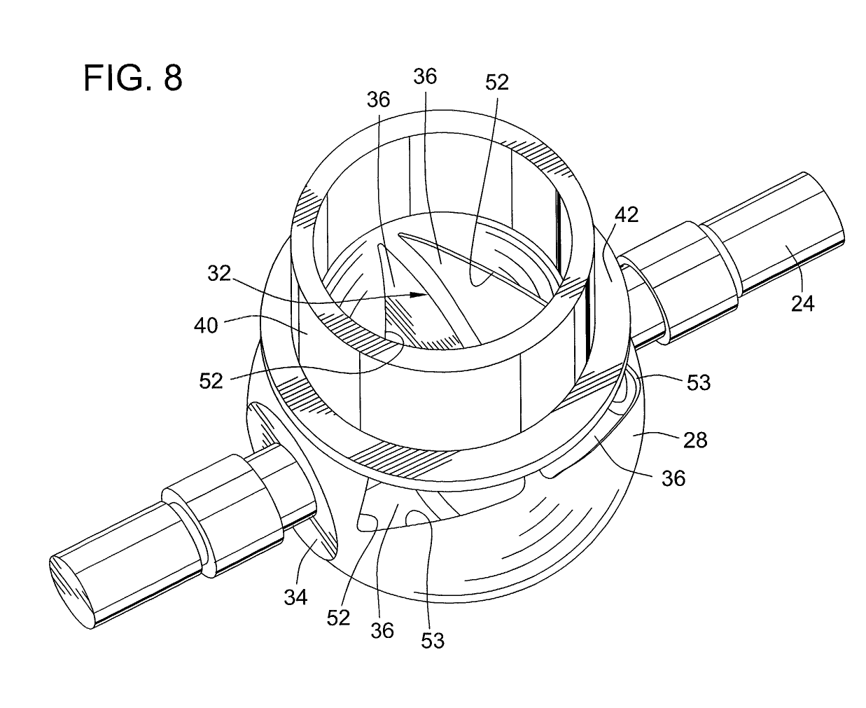

FIG. 7 show a view of the thin wall hollow sphere 28 in a position where the hollow sphere valve 20 is partially opened and FIG. 8 shows a of the thin wall hollow sphere 28 in a position where the hollow sphere valve 20 is opened further. The plate 32 splits the metering port 36. As previously discussed, the plate 32 can be located in planes that do not run through the center of the thin wall hollow sphere 28. The shape of the metering port 36 is selected to achieve greater incremental control of fluid flow. For example, as the valve shaft 24 is incrementally rotated to increase the port area, the triangular shape of the embodiment shown has a smaller incremental increase in area at small port open positions than a port that is circular in shape. While the metering port shape in FIGS. 3-8 is triangular, those skilled in the art will appreciate that other shapes can be used.

The foregoing description of various embodiments of the invention has been presented for purposes of illustration and description. It is not intended to be exhaustive or to limit the invention to the precise forms disclosed. Obvious modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A valve system comprising:
a valve housing having a flow passage;
a valve shaft rotatably mounted to the valve housing; and
a hollow sphere connected to the valve shaft, the hollow sphere having a sphere wall having ports to allow fluid to enter and exit the hollow sphere;

2. The valve system of claim 1 wherein the sphere wall has a tapered area adjacent to the ports.

3. The valve system of claim 2 wherein the sphere wall has a sphere wall thickness and a thickness of the tapered area ranges from 0.030 inches to the sphere wall thickness.

4. The valve system of claim 1 wherein the hollow sphere has a sphere support structure.

5. The valve system of claim 4 wherein the hollow sphere, the support structure, and the valve shaft approximate a volume of revolution.

6. The valve system of claim 4 wherein the sphere support structure comprises at least one relatively thin circular plate having flat surfaces, the flat surfaces being normal to the axis of the valve shaft.

7. The valve system of claim 6 wherein the circular plate is located to minimize distortion of the hollow sphere where the hollow sphere contacts an adjacent flow path.

8. The valve system of claim 1 wherein at least one of the ports comprises a metering port, the metering port having sharp edged surfaces.

9. The valve system of claim 8 wherein the metering port has a triangular shape.

10. The valve system of claim 1 further comprising at least one component forming an adjacent flow path in fluid communication with the hollow sphere.

11. The valve system of claim 10 wherein the component comprises a plate having a hole, the plate positioned against the sphere.

12. The valve system of claim 11 wherein the plate has a deflection under differential pressure and the hollow sphere has a rigid body deflection due to shaft bending, the deflection matching the rigid body deflection.

13. The valve system of claim 10 wherein the component comprises a hollow tube.

14. The valve system of claim 13 wherein the hollow tube has a stepped diameter.

15. The valve system of claim 13 further comprising a spring to provide a loading force to the hollow tube to bias the hollow tube against the hollow sphere.

16. The valve system of claim 1 wherein the hollow sphere approximates a volume of revolution.

17. The valve system of claim 1 wherein the valve shaft is supported by rolling element bearings.

18. A valve body for a valve system comprising:
a sphere support tube connected to a valve shaft; and
a thin walled sphere having ports, the thin walled sphere attached to the sphere support tube;

19. The valve body of claim 18 wherein the thin walled sphere is tapered adjacent to at least one of the ports.

20. The valve body of claim 18 further comprising at least one sphere support plate for supporting the thin walled sphere, the sphere support plate having flat surfaces that are normal to an axis of the valve shaft.

21. The valve system of claim 20 wherein the sphere support plate is located to minimize distortion of the thin walled sphere where the thin walled sphere contacts an adjacent flow path.

22. The valve system of claim 18 wherein the sphere support plate is located to minimize the material stress levels to allow high differential pressure operation.

23. The valve body of claim 18 wherein at least one of the ports is a metering port having sharp edged surfaces.

24. The valve body of claim 18 wherein the thin walled sphere is hollow.

25. The valve body of claim 24 wherein the valve shaft is supported by rolling element bearings.
